(19) United States
(12) Patent Application Publication
(10) Pub. No.: US 2009/0048896 A1
(43) Pub. Date: Feb. 19, 2009

(54) Work management using integrated project and workflow methodology

(76) Inventor: Vignesh Anandan, Hoboken, NJ (US)

Correspondence Address: Allan Chan, Suite 700, 225 Broadway, New York, NY, 10007, US

(21) Appl. No.: 11/893,362

(22) Filed: Aug. 14, 2007

(51) Int. Cl. G06Q 10/00; G06F 17/30; G06F 17/40

(52) U.S. Cl. 705/9

(57) ABSTRACT

In the preferred embodiment, the operational process management methodologies are used to orchestrate the individual activities and project management methodologies are used to manage the schedule, cost, resources and other task attributes of that activity. The system is implemented such that we can fully leverage all standard project management features and operation management features available in existing tools while enabling us manage activities using both the methodologies. This enables managers to fully leverage both process management and project management functionality simultaneously without having to choose one or the other. Using a process increases the quality and consistent of the end result as the same process is repeated consistently. In the preferred embodiment, operational process management methods helps coordinate and monitor the individual activities more effectively and project management methods enable us to manage various activities in an organization in one or more projects which in turn helps better manage the schedule, cost and resources of the individual activities.

### FIELD OF INVENTION

The present invention relates to project management and more specifically to developing and managing a project plan by leveraging processes and operational information in a project. It involves using a methodology that combines operational process management and project management techniques to manage a project.

### BACKGROUND

Below is a description of the conventional project management and operations process management both of which are used to manage work activities:

Project management tools are used to manage projects. A project is a temporary endeavor undertaken to create a unique product or service. It is managed using tasks which are work units that have a specific start date, end date and other properties. Tasks can be dependent on other tasks based on the start date or end date of the task. A set of tasks can also be grouped together to form a parent task. A parent tasks has the same properties as regular task but the start date and end dates are based on the start and end dates of the child tasks. Some of the project management tools in the market are: Microsoft projects, Mercury IT Governance control and Primavera. Project management tools are ideal when we need to manage schedule, cost and resources of a multitude of tasks. The current invention will focus on improving on the features currently available in project management tools.

Operations process management tools are used to manage operational processes such as change management, request management etc. Operation processes are activities performed by organization repeatedly. They are managed by creating a well-defined process that is repeated for a set of items. One of the approaches to operations process management involves defining a process which contains a set of states and transitions between those states. A state represents the current activity being performed for the item or the current state of the item. An item starts in an initial state and then gets transition to other states as users provide input regarding work performed on that item. The new state represents the new activity being performed for the item or the new state of the item. States and transition represent the unit of work in an operational process. An item can be in only one state at any one point in time. Some of the operations process management tools in market are: Serena Team Track, Mercury IT Governance control and Remedy. The primary benefit of using operational process management is the ability to ensure that a well defined process is followed. This in turn increases quality of the end product or service. Since all the items go through the same process they can also be managed as a single group with the same properties and functions.

### Limitation of Existing Project Management Tools

Similar to operational activities where an activity is repeated many times based on well-defined process, in large project that span many months/years there are certain activities that are repeated based on a process. For example, in a building project, activities such as electrical work, plumbing, painting are consistently repeated for all units in a building.

In conventional project management the repetitive activities are managed as a set of tasks in the project plan. The tasks can be added individually or can be added using a task template that contains all the tasks and task dependencies for a single activity. The limitation with this method is that it does not enable us to use operational process management methodologies to manage the activities. We need to use the limited features of project management methodologies for process orchestration.

Another approach is to use management tools such as Mercury ITG which come with both project management modules and operations process management modules. These tools allow project managers to associate a single operational activity that is orchestrated using a process with a single task in the project. The task is marked complete when the process of the activity completes. Using these tools we can manage repetitive activities using operation process management and still monitor them in the project plan using a single task for each activity.

The problem with this approach is that the individual process steps of each activity are no longer maintained as tasks in the project and cannot be used in project scheduling and project costing. We are limited to managing the entire activity using a single task in the project plan. Thus by using operational process methodology we make project management less effective.

### SUMMARY OF THE INVENTION

An object of the present invention is to provide a project management methodology that will overcome the shortcoming of conventional project management methodologies when dealing with projects that have operational (repetitive) activities.

An object of the present invention is to provide a methodology where an operational activity can be orchestrated as a process and also be managed using a set of tasks.

Another object of the present invention is to provide a mechanism to manage the tasks of the activities in a project along with other project tasks.

Another object of the present invention is to enable tasks in a process to have dependencies and constraints. These dependencies and constraints are repeated for each activity of the process.

Another object of the present invention is to enable tasks and state changes of a process to be dependent on one another. These dependencies are repeated for each activity of the process.

By allowing operational activities to have tasks that are managed in projects we ensure that the activities can be fully used in project scheduling and costing.

By allowing state changes and tasks in the process to interact with one another we ensure that the state changes, which represent work units, can be used in project scheduling and costing.

### BRIEF DESCRIPTION OF THE DRAWING

FIG. 1 shows the Software architecture used by the invention

FIG. 2 shows a graphical representation of a process

FIG. 3 shows an activity table with activities

FIG. 4 shows a project with activities

FIG. 5 shows a form used to orchestrate a single activity

FIG. 6 shows the novel and core features of each module in the software architecture

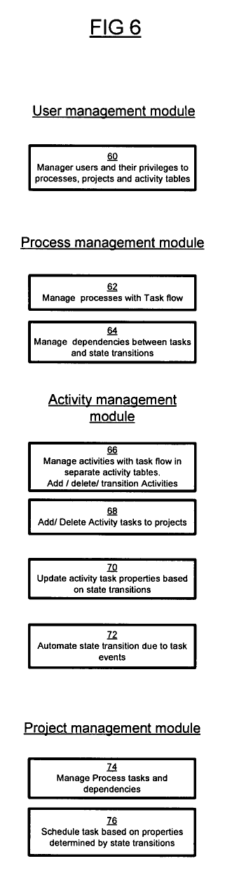

FIG. 7 shows the data structure used in the invention

FIG. 8 shows the high-level process that users can use to leverage the software

FIG. 9 shows the process to setup an activity in the system

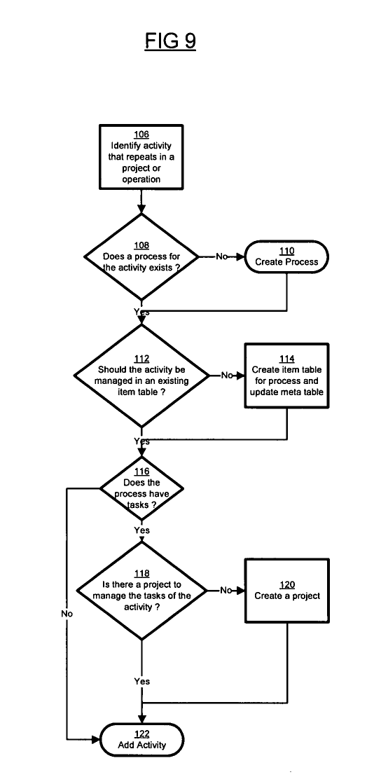

FIG. 10 shows the process to create a process

FIG. 11 shows the process to add an activity when work is performed for that activity

FIG. 12 shows the process used to manage an activity when work is performed for that activity

FIG. 13 shows the process used to manage an activity when the project used to manage the activity is updated

FIG. 14 shows the process used to take corrective action when an activity is no longer needed

FIG. 15 shows the process used to take corrective action when the process of the activity changes

### DETAILED DESCRIPTION

Example methods and systems are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify the description.

The preferred embodiment of the present invention allows managers to use both project management methods and operational process management methods together to manage repetitive activities in an organization.

### System Architecture—Preferred Embodiment

The system and method may be implemented in the form of a software application running on a computer system such as a mainframe, personal computer, handheld computer, server etc. The computer system may be linked to a database. The link may be, for example, via a direct link such as a direct hard wire or wireless connection, via a network connection such as a local area network or via the internet.

The computer system may include a central processing unit (CPU), memory, a printer interface, a display unit, a LAN (local area network) data transmission controller, a LAN interface, a network controller, an internal bus and one or more input devices such as, for example, a keyboard, mouse, etc. As shown, the system 400 may be connected to a database via a link.

In the preferred embodiment as shown in FIGI, the system consists of a collection of data structures and modules. Data structure store the data used by the application and consists of a set of relational tables. Module encapsulates the business functions performed by the application and consists of distinct functions, user interfaces. A module manages particular data structures in the system. A module has interfaces that are used by other module to access its functionality. Interfaces can be setup using Application programming interfaces (API).

The invention consists of three modules: Operation management module 4, project management module 10 and user management module 2.

Operation management module 4 is used to manage the operational activities by defining a process that is used for each activity. It extends standard operation management features available in most operation management application like Serena Team Track, Remedy, and Mercury IT Governance control. It is consists of the process management module 6 and activity management module 8. The Process management module 6 is used to setup and manage processes and the Activity management module 8 is used to manage the activities and the activity tables that store the activities.

Project management module 10 is used to manage projects and their tasks. It extends standard project management applications like Microsoft projects, Primavera etc.

User management module 2 is used to manage the users that have access to the system. It extend user management applications available as part of most project management and operational management applications.

This invention consists of four data structures: the process data 14 managed by the process management module 6, activity data 16 managed by the activity management module 8, project data 18 managed by the project management module 10 and user data 12 managed by the user management module 2.

The invention provides an embodiment where each module consists of standard features available in existing standard applications and extension features that are unique to this invention. The invention will describe the extension features in details and will also describe how they extend the standard features. The invention will also describe those standard features that are critical to the functioning of the system. Similarly only those data structures that are critical to functioning of the system or unique to this application will be described in detail.

Existing applications can be extended by re-writing the applications with the extension features or we can write a separate extension module that leverages the functionality available in a standard application through an Application programming Interfaces (API).

### Data Structures

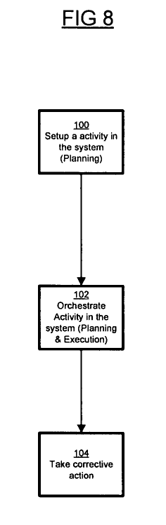

Referring to FIG. 8 in a preferred embodiment.

User data 12 maintain data on the all the users that have access to the system

It consists of a user table 80 which stores user's information. It has ‘User ID’ field to uniquely identify a user.

Process data 14 maintains data on the all the processes defined in the system.

It consists of process table 82, process workflow data table 84, 88 and process task data tables 86, 90.

The process table 82 maintains general data about the processes defined in the system. It has ‘Process ID’ field to uniquely identify a process. It has ‘Process manager’ field that identifies the process manager for the process and contains the ‘User ID’ of the process manager.

The process workflow data tables maintain data on the states and transitions of the workflows 22 of all the processes. It consists of two tables: process state table 84 and process transition table 88 which store information about states and transitions respectively. Both tables have a ‘Process ID’ to identify the process that the state or transition belongs to. The process state table 84 has a ‘State ID’ field to uniquely identify a state in the process. The process state table 84 has a ‘State user’ field that identifies the user who is assigned to the state and contains the ‘User ID’ of the user.

The process transition table 88 has a ‘Transition ID’ field to uniquely identify a transition in the process. The process transition table 88 has a ‘Parent State ID’ and ‘Child State ID’ to identify the parent and child states of a transition. The process transition table 88 also has two fields to manage transitions that depend on tasks. ‘Process task ID’ identify the process task that the transition is dependent on and the ‘Dependency Type’ field specifies the type of the task dependency. The field will have the value ‘Start’ or ‘Complete’ to indicate if the state transition occurs when a task starts or when a task completes.

The process task data tables maintain data on the tasks and dependencies defined in all the processes. It consists of two tables: process task table 86 and process task dependency table 90 which store information about tasks and task dependencies respectively. Both tables have a ‘Process ID’ to identify the process that the task or dependency belongs to. The process task table 86 has a ‘Process task ID’ field to uniquely identify the task in the process. The process dependency table has a ‘Parent Process task ID’ and ‘Child Process task ID’ to identify the parent and child task of the task dependency. Process task table 86 stores only basic task information such as task name, start date, end date and duration. Process task table 86 also has two fields to manage tasks that depend on state transitions. ‘Transition ID’ identifies the transition that the task is dependent on and the ‘Dependency Type’ field specifies the type of the dependency. The ‘Dependency Type’ field will have the value ‘Start’ or ‘Complete’ to indicate if task start or complete when the state transition occurs.

Activity data 16 consists of one or more activity tables and an Activity meta-data table 92.

An activity meta-data table maintains information about all the activity tables in the systems. It has an ‘Activity table name’ field to identify the activity table and a ‘Process ID’ field to identify the process followed by the activities in the table. It has ‘Operational manager’ field that identifies the operation manager for the activity and contains the ‘User ID’ of the operation manager.

An activity table maintains data for a group of activities that follow a particular process. It has ‘Activity ID’ that unique identifies the activity in the given table. It has a ‘Project ID’ field that identifies that project that an activity belongs to. It has a ‘Current state’ field that maintains the current state of the activity and contains the ‘State ID’ of the state defined in the process.

Activity information for a particular activity task can be accessed by the project management module 10 using the Activity table and the Activity ID of the activity.

Project data 18 consists of a project table 98, task table 100 & task dependency table 102.

The project table 98 maintains data on all the projects in the system. It has ‘Project ID’ field to uniquely identify a project. It has ‘Project manager’ field that identifies the project manager for the project and contains the ‘User ID’ of the project manager. It has a ‘Lock’ field to identify transaction currently holding the lock for the project. This could be a transaction started by a project manager or the activity management module 8.

The task table 100 maintains data on all the tasks in a project. It includes regular tasks and also tasks that belong to an activity. It has a ‘Task ID’ field to uniquely identify a task. It has a ‘Project ID’ field that identifies the project that the task belongs to. Tasks that belong to an activity use four additional fields: ‘Activity Table Name’, ‘Activity ID’, ‘Process task ID’, ‘Start Allowed’ and ‘Completed Allowed’. These fields will not contain any data for tasks that don't belong to any activity. ‘Activity Table Name’ identifies the activity table that the activity belongs to. ‘Activity ID’ field identifies the activity in the activity table. ‘Process Task ID’ field identifies the task in the defined process that the current task maps to. For tasks that are dependent on state transitions to occur, the ‘Start Allowed’ and ‘Completed Allowed’ fields are flagged ‘yes’ to indicate that the task is allowed to start or complete as the state transition it depends on has occurred.

The task dependency table 102 maintains data on all the task dependencies that exists between tasks in all projects. This includes dependencies of activity task defined in a process. It has a ‘Parent task ID’ and ‘Child task ID’ to identify the parent task and child task in the task dependency.

Activity task information for particular activity can be accessed by the activity module using the Project ID, Process Task ID and Process Task Dependency ID of the task.

### Modules

### User Management Module 2

### Standard Features

### Create, Delete and Modify Users

### Extension Features

In an alternative embodiment, users need special privilege to create and delete projects, processes and activity tables.

In an alternative embodiment, users cannot be deleted if they are project managers for projects, process manager for processes, operation managers for activity tables or are assigned to a state in a defined process.

### Process Management Module 6 (Operation Module 4)

### Standard Features

Standard features include the ability to setup and manage processes which contain workflows. It includes a graphical interface to design the process and update it.

When a process is created it is assigned to a single process manager who is responsible for maintaining the process.

When an existing process is modified all the activities that follow the process are updated through the activity management module 8.

A process cannot be deleted while there are activities that follow the process.

It maintains the process data using only the process table and process workflow tables.

### Extension Features

In an alternative embodiment, we can create a task flow 20 for a process which consists of tasks and task dependencies 62. We can then setup tasks to be dependent on state transitions and state transitions to be dependent on tasks 64. Graphical interface is included to setup the task flow 20 and the dependencies between state transitions and tasks.

### Activity Management Module 8 (Operation Module 4)

### Standard Features

We can setup activity tables for a particular process. When an activity table is created it is assigned to a single operation manager who is responsible for maintaining the activity.

Operation manager submit activities that are stored in the activity table. The activities are then transitioned from one state to another by users based on the process. Operation managers can also delete activities from the activity table.

Users have a graphical interface to view all the activities that are assigned to them and to transition them to the next state. Operation manager have a graphical interface to manage the activities.

Activity management module interacts closely with the process management module.

When a process changes, all the activities that follow the process are updated. When the state is removed, all the activities with that state are transitioned to the previous state.

### Extension Features

In an alternative embodiment, when adding an activity we specify the project that the activity will be associated with.

When the activity is added to the activity table, the tasks and dependencies for that activity as defined in the process are added to the project assigned to the activity. When an activity is removed from the activity table, the activity tasks and dependencies of the activity are removed from the project 68.

Activity module can update a project only if it acquires the necessary locks. If it is unable to acquire the necessary locks all the transactions that need to update the project will either wait or fail.

When an activity reaches a state which has state transitions that depend on an activity task starting or completing, it checks regularly with the project management module 10 if the task has started or completed. If the task event has occurred it automatically performs the transition. If not, it waits until the task event occurs to perform the transition 72. These transitions cannot be performed by regular user. A state can also have one transition that depends on a task event and another regular transition. In this case users can perform their regular transition before the automated transition occurs.

An activity task can be configured to start or complete when a state transition occurs for its activity. When the state transition occurs the activity module updates the ‘Start Allowed’ or ‘Completed Allowed’ columns in the project table for the tasks that are depended on the state transition 70. This notifies the project management module 10 that the task can now be started or completed. This update is done through the interface provided by the project management module 10.

An activity can also be switched from one project to another. Here again, the activity table is updated and activity is removed from the source project and added to the target project.

When a process is updated all activities that follow the process are also updated. An activity task can be removed, added or updated depending on the change.

### Project Management Module 10

### Standard Project Management Features

Standard features includes the ability to create projects, add task, delete tasks, setup up task dependencies, update project progress information, manage resources, establish baselines, calculate project efficiency etc. It also includes graphical interfaces such as network diagram, Gantt chart etc to manage the project.

When a project is created it is assigned a project manager who maintains the project.

### Extension Features

In an alternative embodiment, project module has an interface that enables Activity module to view, add, remove and modify the tasks and task dependencies in all the projects.

The operation module 4 can make changes to a project only if it acquires the necessary locks for the project. If it is unable to acquire the necessary locks those operation module transactions that try to update the project will either wait for the lock or fail with the appropriate message.

Activity tasks and dependencies are added to a project by the Operation module 4 when operational managers create activities that are assigned to the project. When the activity is deleted its activity tasks and dependencies are deleted from the project. Activity tasks and dependencies can also be added or removed when the process of the activities changes. When activity tasks are initially added they are added using the start, end and duration information defined in their process 74.

Tasks and task dependencies that belong to an activity can be deleted only if the activity is deleted.

The activity task is not allowed to start when the “Start Allowed” column is set to false. If the start date configured is earlier than the current date then the start date is automatically set to the current date. Similarly, the task is not allowed to complete when the “Complete Allowed” column is set to false. If the complete date configured is earlier than the current date then the complete date is automatically set to the current date. These columns are set by the operations module to ensure that an activity task starts or completes only when the state transition it depends on occurs for the activity 76.

Other than these unique features, activity tasks behave as regular tasks. A task can be updated with progress information, setup with additional task dependencies etc.

A project cannot be deleted until all its activities are deleted.

### The System

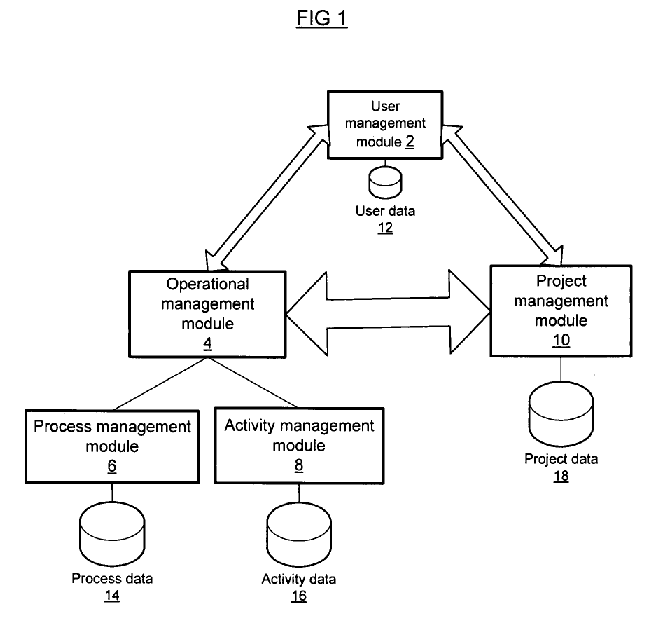

In one embodiment, a computer system shown in FIG. 1 may be used to orchestrate and manage pre-defined repetitive activities in an organization by defining a process that is repeated for each occurrence of that activity. In the preferred embodiment, the operational process management methodologies are used to orchestrate the individual activities and project management methodologies are used to manage the schedule, cost, resources and other task attributes of that activity.

Using a process increases the quality and consistency of the end result as the same process is repeated consistently. In the preferred embodiment, operational process management methods helps coordinate and monitor the individual activities more effectively and project management methods enable us to manage various activities in an organization in one or more projects which in turn helps better manage the schedule, cost and resources of the individual activities.

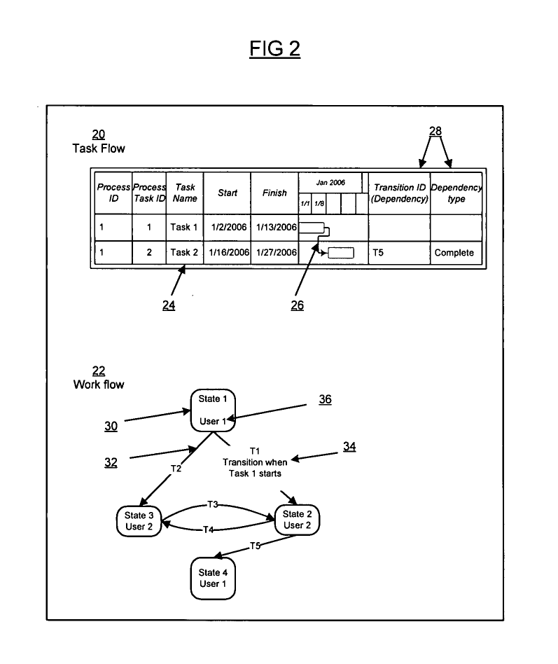

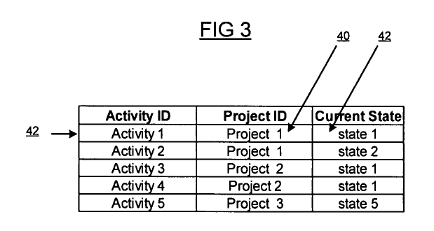

A process manager in an organization defines a process illustrated in FIG. 2 which may consists of at least one workflow 22 and a task flow 20 which is repeated for all activities that follow the process shown in FIG. 3.

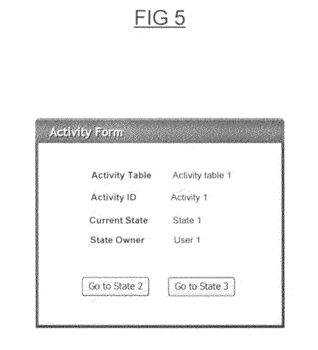

Referring to FIG. 2 in a workflow 22 a set of states 30 is predefined by the user which may represent units of works and the user defines how work may be transitioned from one state to another state 32 before it reaches a final state. When an activity reaches the final state the total work represented by the workflow 22 is considered to be complete. Each state is assigned to a specific user 36 who is responsible for performing the transitions after completing their part of the work. In the preferred embodiment, when the assigned user performs the transition the user assigned to the next state is notified to start working on their part of the work. This method enables to coordinate activities effectively and efficiently. FIG. 5 shows one example of the form that users who are assigned to the state will use to transition the activity to other states.

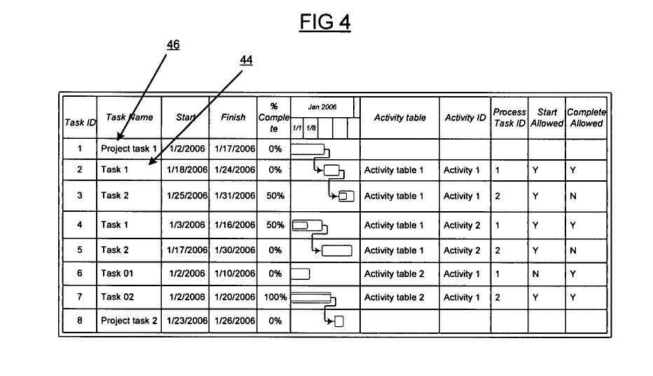

A task flow 20 may contain tasks 24 and dependencies between those tasks 26. These tasks are repeated for the all activities that follow the process. The tasks of an activity 44 are managed in projects along with other tasks in an organization 46 as show in FIG. 4. Projects enable us to effectively manage the cost, schedule and resources of the individual tasks and by defining the tasks as part of the process we ensure that the defined process is followed for the all the activities. In the preferred embodiment an activity 42 is assigned to a single defined project 40 and all the tasks that are part of that activity 24 are added to that project and managed along with other tasks in that project.

In the present invention, the preferred arrangement, at least one workflow 22 and at least one task flow 20 in a process can interact seamlessly by setting up dependencies between the tasks and state transitions. For example, the system may be setup where a process transition from one state to another in a workflow 22 occurs when a certain task event occurs 34. Task events may include task conditions such as but not limited to: task started or task completed. We can also setup a task to be dependent on a particular state transition to occur in a workflow 28. In the preferred embodiment, the task can be configured to start or complete based on when the state transition occurs. The present invention enables managers to fully leverage both process management and project management functionality simultaneously without having to choose one or the other.

Commonly known in the art, projects are managed by project managers. Using a project plan they manage the schedule, cost and resources of all the project tasks. They update the project with progress information, monitor the project closely and make changes to the plan if necessary. A project can contain regular tasks 46 and also tasks of various process activities 44.

Once the process is defined and the necessary projects are created, activities then can be added that can be orchestrated and managed using both the workflows 22 and tasks defined in the process 20.

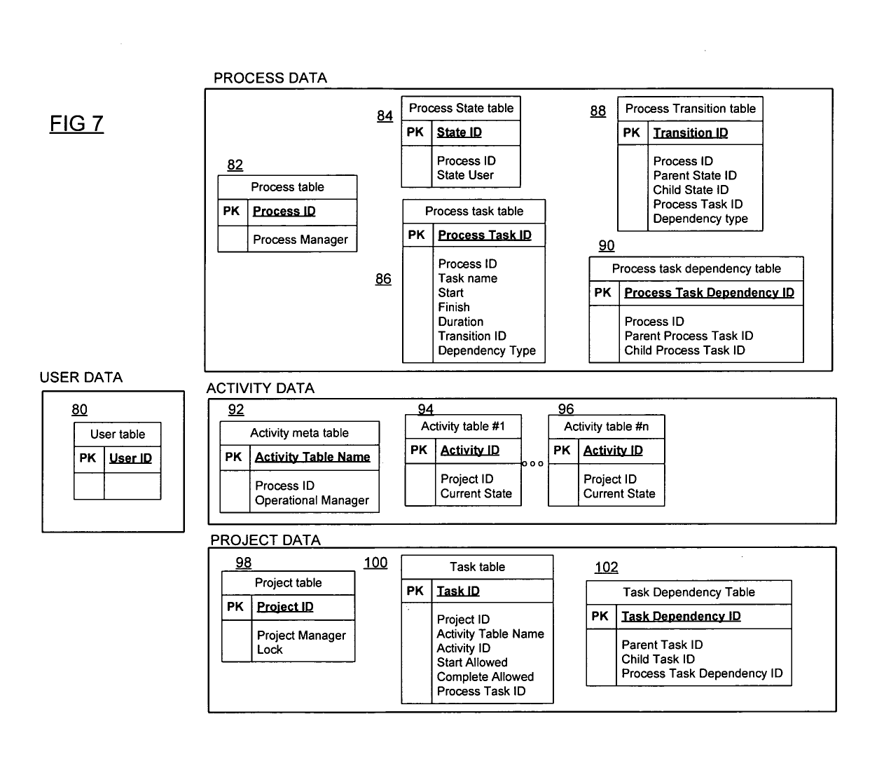

Referring to FIG. 7 both activity information and project information are stored in a relational format that enables us to leverage project information when managing activities and use activity information when managing a project.

The system is implemented such that we fully leverage all standard project management features and operation management features available in existing tools while enabling us to manage activities using both the methodologies.

### Process

An organization that has implemented the solution described in this invention can leverage the invention using the method defined in FIG. 8.

In the preferred embodiment, the overall approach is to: setup a repetitive activity in the system 100, orchestrate the activity 102 and take corrective actions when an unplanned change occurs in the activity 104.

### Setup Activity

In the present invention, a project manager or operational manager ideally needs to identify repetitive activities in their projects or operations that need to be managed using both project and operational management methodology 106. These are activities that follow a clearly defined process and need to be orchestrated using the process and managed in a project along with other tasks in a project.

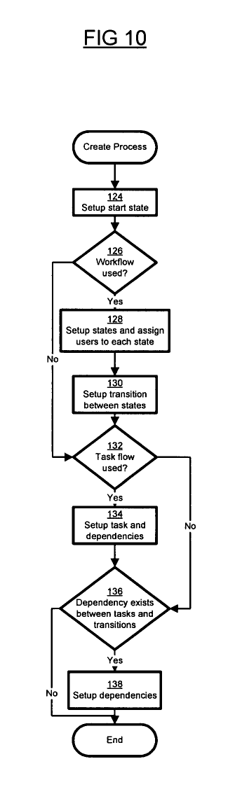

A process needs to be created for the activity 10 as show in FIG. 10. If the process already exists then that process may be selected from a pool of pre-existing processes. When creating a process a start-state 124, 30 may be specified. If workflow 22 is used then states 30 are created, with a user for each state 36, and transitions between those states 32, 128, 130. If task flow 20 is used then tasks 24 are setup and dependencies between those tasks 26, 134. Then dependencies between tasks and transitions in the process 28, 34, 138 may be setup.

Once a process is created or identified, an activity table needs to be created to store the activity 114. An existing activity table that follows the process can also be used instead.

If the process defined for the activity has a task flow 20 defined then we need a project to store the tasks of the activity. An existing project may be used or the user may choose to create a new project 120.

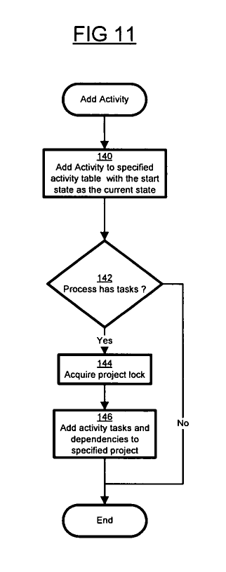

As shown in FIG. 11, once we have the necessary process, activity table and project setup we can add the activity to the activity table with start state as the current state of the activity 140. In one embodiment, if the activity has tasks then we need to acquire a project lock 144 and add the activities tasks to the defined project 146 to complete the setup operation.

### Orchestrate Activity

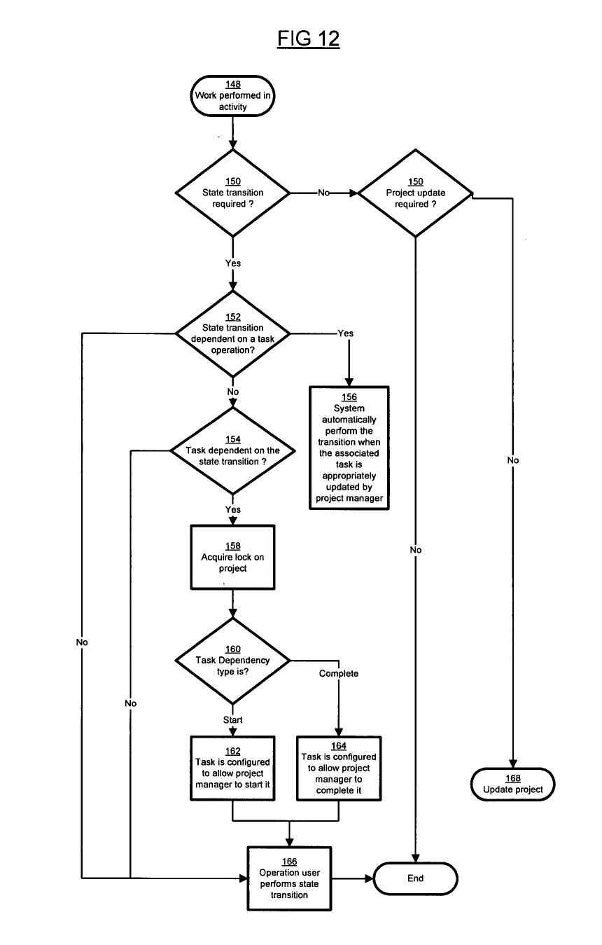

In the preferred embodiment, once the activity is setup in the activity table and project we can start orchestrating and managing the activity. As shown in FIG. 12 when work is performed that requires a change in state of the activity, then the state transition is performed either manually by the state user 166 or automatically by the system when the task operation that a transition depends on occurs 156.

In one embodiment, if there are tasks that depend on the transition then before the transition are performed, the project associated with that dependent task needs to be updated to allow the task to either start or complete based on the type of the dependency that is setup 162,164.

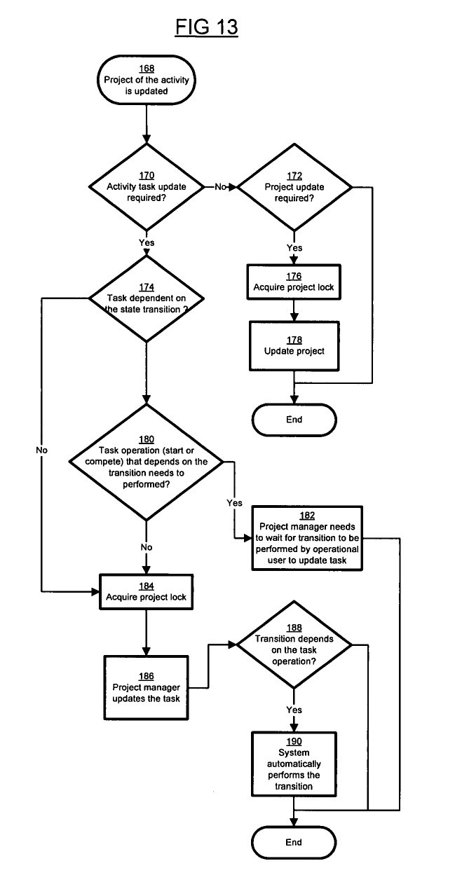

The method is further described with reference to in FIG. 13, where projects which include activity tasks can be updated for planning purposes or to update the project plan with progress information. Ideally, a project manager needs to acquire a lock on the project to update it 178,184. If an activity task update such as task start or task complete is dependent on a state transition, then the project manager needs to wait for that transition to occur before performing the update 182. Once the transition occurs the project manager can then perform the necessary task updates. And when an activity task that has dependent transitions is updated, the system automatically performs those transitions when the activity reaches the parent state 190.

### Take Corrective Action

Once an activity is setup and managed in the system, managers might encounter unplanned changes in the activity that will require them to take corrective actions. This could involve an activity that is no longer necessary or an activity where the process the activity follows has changed.

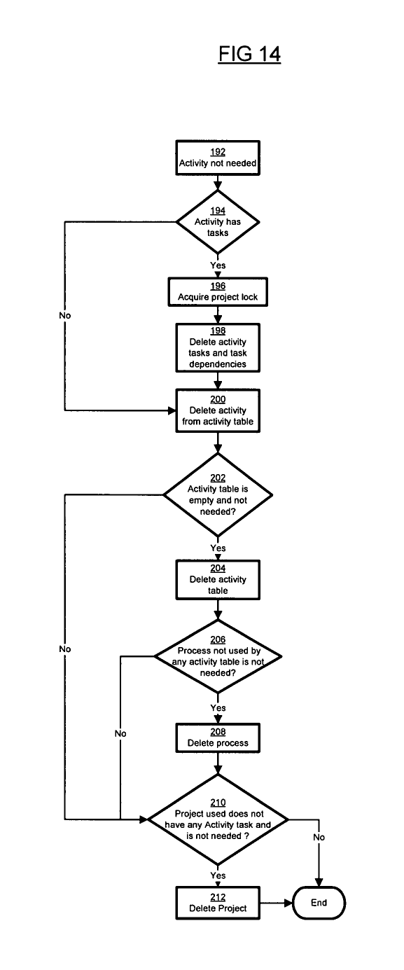

In one embodiment, as shown in FIG. 14, when an activity is no longer needed, we can delete the activity after deleting the task and task dependencies from the project that the activity belongs to and remove the activity from the activity table 196,198,200. We can remove the activity table if it is empty and will no longer be used 204. Similarly, we can also remove a process if there are no activity tables for that process 208. We can also remove the project if it does not contain any activity tasks and is no longer necessary 212.

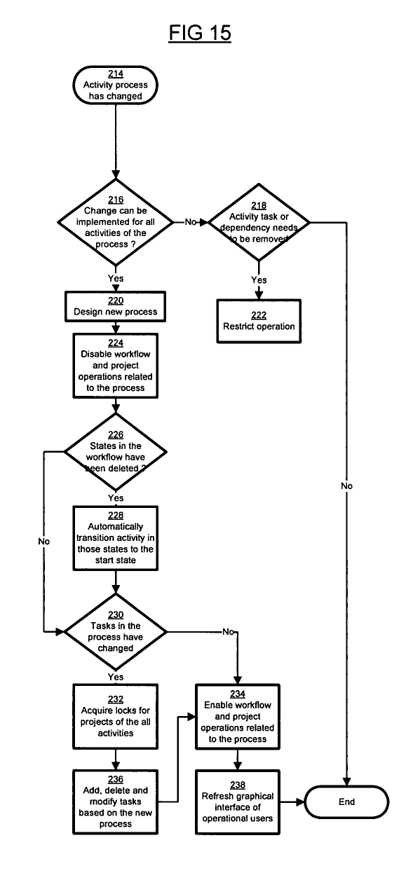

In one embodiment, as shown in FIG. 15, if a process for the activity has changed then we can change the process only if that change will be valid for all other activities that follow the process. Note that operations such as deleting activity tasks or task dependencies cannot be performed without updating the process 222.

As described in the preferred embodiment, to change a process, we should first design an updated process 220. We then need to disable workflow and project operations related to the process 224. If states in the workflow 22 have been deleted then transition all the activities with that state to start state 118. If tasks in the process have changed then make those task changes in all projects with activities of that process 236. Once the activity table and projects have been updated then we can enable all the workflow and project operations 234. We also need to refresh the interface of operation users due to changes in state information of the activities 238.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claim is:

1) A computer-implemented method for process instrumentation using a project, comprising:
a) operational management module that manages processes with task flow and orchestrates its activities;
b) project management module that manages the projects with activities;
c) provide coordination between the Operational management module and Project management module; and
a) a relational database implementation that allows integration of operational data and project data.

2) A computer-implemented method for process instrumentation using a project, comprising:
a) operational management module that manages processes with task flow and orchestrates its activities;
b) project management module that manages the project with activities;
c) provide coordination between the Operational management module and Project management module;
d) when a process or activity that uses a project gets updated the appropriated changes are coordinated in the project; and
e) when a project used by activities gets updated the appropriated changes are coordinated in the activities.

3) A computer-implemented method for process instrumentation using a project, comprising:
a) operational management module that manages processes with task flow and orchestrates its activities;
b) project management module that manages the project with activities;
c) provide coordination between the Operational management module and Project management module;
d) when a process or activity that uses a project gets updated the appropriated changes are coordinated in the project;
e) when a project used by activities gets updated the appropriated changes are coordinated in the activities;
f) updating said project by the operational management module upon transitioning, adding or deleting of an activity that uses the project; and
g) transitioning an activity to another state upon an occurrence of a task event.

4) A computer-implemented method for process instrumentation using a project, comprising:
a) identifying repetitive activities that require process instrumentation using a project
b) setting up a process for each activity
c) setting up activity table for each activity
d) setting up project for each activity
e) setting up activity for workflow orchestration and project management; and
f) manage activity simultaneously using workflow and project.

5) A computer-implemented method for process instrumentation using a project, comprising:
a) identify repetitive activities that require process instrumentation using a project;
b) setup a process for each activity;
c) setup task flow for process;
d) setup workflow for process;
e) setup dependencies between task flow and workflow;
f) setup activity table for each activity;
g) setup project for each activity;
h) setup activity for workflow orchestration and project management; and
i) manage activity simultaneously using workflow and project.

6) A computer-implemented method for process instrumentation using a project, comprising:
a) identifying repetitive activities that require process instrumentation using a project;
b) setting up a process for each activity;
c) setting up activity table for each activity;
d) setting up project for each activity;
e) setting up activities for workflow orchestration and project management;
f) setting up activity in activity table;
g) setting up activity tasks in project; and
h) managing activities simultaneously using workflow and project.

7) A computer-implemented method for process instrumentation using a project, comprising:
a) identifying repetitive activities that require process instrumentation using a project;
b) setting up a process for each activity;
c) setting up activity table for each activity;
d) setting up project for each activity; and
e) setting up activity for workflow orchestration and project management.

8) A computer-implemented method as in claim 4; whereas said simultaneous management of activities which include restricting certain operations of activity tasks through project management module.

9) A computer-implemented method as in claim 4; whereas said simultaneous management of activities which include restricting the operation of activity tasks based upon a predefined transition occurrence;

10) A computer-implemented method as in claim 4; whereas said simultaneous management of activities which include automatically commencing a workflow transition occurrence of a task event within the process task;

11) A computer-implemented method as in claim 4; whereas said simultaneous management of activities which include commencing or ending activity tasks based upon predefined transition occurrences;

12) A computer-implemented method as in claim 4; whereas said simultaneous management of activities which include transitioning an activity to another stated manually or upon an occurrence of a task event;

13) A computer-implemented method as in claim 4; whereas said simultaneous management of activities which include preventing the deletion of tasks and tasks dependencies within an activity unless the activity itself is deleted;

14) A computer-implemented method as in claim 4; whereas said simultaneous management of activities which include viewing project data when managing activity

15) A computer-implemented method as in claim 4; whereas said simultaneous management of activities which include viewing operation data when managing project
